(19) United States
(12) Patent Application Publication
(10) Pub. No.: US 2016/0350848 A1
(43) Pub. Date: Dec. 1, 2016

(54) Systems And Methods For Providing Group Accounts

(71) Applicants: Ravi Acharya, Philadelphia, PA (US); Margaret Haggerty, New York, NY (US); Kashif M. Siddiqui, Livingston, NJ (US)

(72) Inventors: Ravi Acharya, Philadelphia, PA (US); Margaret Haggerty, New York, NY (US); Kashif M. Siddiqui, Livingston, NJ (US)

(73) Assignee: JPMorgan Chase Bank, N.A.

(21) Appl. No.: 12/915,719

(22) Filed: Oct. 29, 2010

Related U.S. Application Data
(60) Provisional application No. 61/370,582, filed on Aug. 4, 2010.

(51) Int. Cl. G06Q 40/00

(52) U.S. Cl. CPC G06Q 40/02

(57) ABSTRACT

The invention includes a system and method to provide a group account in the form of a financial fund, and implemented by a tangibly embodied computer processing system. The group account is maintained on the computer processing system. The method may include maintaining, by the computer processing system, the group account, and the group account being associated with a plurality of customers who each have selective access to the account, such selective access determined by a rule set disposed in the computer processing system, each of the plurality of customers having an interest in the group account. Processing may include the computer processing system (1) inputting credentials from one of the plurality of customers in a session; (2) comparing the input credentials with the rule set to determine access to the group account to be provided to the customer; (3) generating, based on the comparing, a graphical user interface presenting the customer with access options; (4) outputting the graphical user interface, with the access options, to the one of the plurality of customers; (5) inputting, from the one of the plurality of customers, a selection of one of the access options; and (6) performing processing in response to the selected access option.

### RELATED PATENT APPLICATION

This application claims priority to U.S. Provisional Patent Application 61/370,582 filed Aug. 4, 2010, the content of which is incorporated herein by reference in its entirety.

### FIELD OF THE INVENTION

The invention relates generally to systems and methods for providing financial accounts to customers.

### BACKGROUND OF THE INVENTION

Financial accounts are widely used by both individuals and entities to track, measure, and record the flow of funds. In particular, a commonplace financial account records the net value of deposits and debits that are associated with that particular account. Financial accounts may be maintained by a bank or some other financial institution.

In the art, a wide variety of functionality are associated with financial accounts and a customer's experience in working with a financial account. However, the prior art in this area has shortcomings. The systems and methods of the invention address various such shortcomings in a novel manner.

### BRIEF SUMMARY OF THE INVENTION

The invention includes a system and method to provide a group account in the form of a financial fund, and implemented by a tangibly embodied computer processing system. The group account is maintained on the computer processing system. The method may include maintaining, by the computer processing system, the group account, and the group account being associated with a plurality of customers who each have selective access to the account, such selective access determined by a rule set disposed in the computer processing system, each of the plurality of customers having an interest in the group account. Processing may include the computer processing system (1) inputting credentials from one of the plurality of customers in a session; (2) comparing the input credentials with the rule set to determine access to the group account to be provided to the customer; (3) generating, based on the comparing, a graphical user interface presenting the customer with access options; (4) outputting the graphical user interface, with the access options, to the one of the plurality of customers; (5) inputting, from the one of the plurality of customers, a selection of one of the access options; and (6) performing processing in response to the selected access option.

### BRIEF DESCRIPTION OF THE DRAWINGS

The present invention can be more fully understood by reading the following description together with the accompanying drawing, in which like reference indicators are used to designate like elements, and in which:

FIG. 1 is a schematic diagram showing a group account system, in accordance with one embodiment of the invention;

FIG. 2 is a block diagram showing further details of a group account system, in accordance with one embodiment of the invention;

FIG. 3 is a high-level flowchart showing aspects of group account (GA) related processing in accordance with embodiments of the invention.

FIG. 4 is a flowchart showing in further detail the “perform processing to set up group account” processing of FIG. 3 in accordance with one embodiment of the invention.

FIG. 5 is a flowchart showing in further detail the “establish parameters of group account in session with primary customer” processing of FIG. 4 in accordance with one embodiment of the invention.

FIG. 6 is a flow chart showing in further detail the “perform ‘group account’ transaction processing in session with customer” processing of FIG. 4, in accordance with one embodiment of the invention.

FIG. 7 is a flowchart showing in further detail the “perform processing in accord with close parameters of the group account in accordance with one embodiment of the invention.

FIG. 8 is a diagram showing a group account listing and an associated group account record in accordance with one embodiment of the invention.

FIG. 9 is a diagram illustrating examples of the group account processing described herein, in accordance with embodiments of the invention.

FIG. 10 is a flowchart showing a use case example, relating to a soccer team, of the group account processing in accordance with one embodiment of the invention.

FIG. 11 shows an illustrative graphical user interface (GUI) that may be generated by the bank platform and displayed on the customer's computer in accordance with one embodiment of the invention.

FIG. 12 shows an illustrative graphical user interface (GUI) that may be generated by the bank platform and displayed on the customer's computer in accordance with one embodiment of the invention;

FIG. 13 show further aspects of the group account in accordance with embodiments of the invention;

FIG. 14 is a block diagram showing the tools processor of FIG. 2 in further detail in accordance with one embodiment of the invention; and

FIG. 15 is a table showing a customer record of FIG. 8, in accordance with one embodiment of the invention.

### DETAILED DESCRIPTION OF THE INVENTION

Hereinafter, aspects of systems and methods for providing a group account in accordance with various embodiments of the invention will be described. As used herein, any term in the singular may be interpreted to be in the plural, and alternatively, any term in the plural may be interpreted to be in the singular.

As used herein, the terms “information” and “data” are used interchangeably.

The invention relates to a “group account” and associated credentials, such as “group account cards” (GA Cards), as well as systems and methods of using the group account. The group account provides functionality such that a group of persons may respectively interface with the group account, so as to perform transactions, secure information, and perform various other activities. The group account may be supported by a suitable banking platform.

As used herein, an “account” means a fund that is entrusted to a bank and maintained on a tangibly embodied bank platform, the fund maintained as a record of financial transactions that records the net value of credits and debits that are associated with that particular account, and the bank platform being in the form of a computer processing system. Relatedly, a “group account” as used herein means an “account” that is associated with a plurality of customers who each have an interest in the account, in conjunction with the plurality of customers possessing varying levels of access to the account, the access providing each customer access to information and/or access to processing tasks. As used herein, the terms “customer” and “user” are used interchangeably. Relatedly, as used herein, the term “customer” and/or “user” means a primary customer and/or a participant customer, or any other person who accesses or otherwise uses a group account.

In particular, a problem the invention addresses is intermingling of funds into a private account. That is, in a fund raiser for example, a common situation occurs when a particular person (e.g. one of the parents) is designated to be the collection person. During the course of the fund raiser, all the other parents give their raised money to the particular collection person over some period of time. In turn, the collection person, being provided with no alternative, deposits the collected funds into their personal checking account. As a result, the collected funds are intermingled with the collection person's own personal funds. In addition, tracking of the funds is often cumbersome and difficult. For example, monies may well be given to the collection person in hampered situations, such as when the collection person is packing up after a practice or other wise on the run.

The group account of the invention addresses the intermingling problem, as well as other problems. The group account of the invention may be directed to any situation in which a number of people in a group need to interact with an account, which is associated with the group. For example, a group account of the invention may be used in a situation where there is a need for various persons (coaches, parents, administrators, trustees) to interface with an account for purposes of running a fund raiser for a team. However, the group account may be utilized with a wide variety of situations, such as with other fund raisers, a bridal shower where persons are contributing to collectively purchase items, any other collective purchase, a fantasy football league, a fund collection for a particular event, or a fund collection for a particular season, and in particular a specific sports season, for example

In accordance with one aspect of the invention, the group account employs access control to users, i.e., persons, interfacing with the account. Specifically, the banking platform (that supports the group account) controls access to the group account based on access rights provided to a particular user, i.e., what access options are provided to what customers. For example, an administrator user (or primary customer) of the particular group account may be authorized to perform any activities such as deposit funds, withdraw funds, or secure statements of the account for example. On the other hand, a parent user (or participant customer) may be provided with access such that the parent may only make deposits and view the current balance of the account. The parent user might not be provided access to make withdrawals or view complete history of the account. In one embodiment, it might be required for fund transfers to be cleared by an administrator, or in some other way reconciled, prior to such fund transfers being visible to another type or user, i.e., one with different access rights.

Access control may be provided in various ways. For example, access may be controlled based on the particular group account card (and credentials stored thereon) that is provided to a user—and used to interface with the group account. On the other hand, access control might be performed by other credentials that are provided to a particular user, such as username/password. Alternatively; access may be controlled based on attributes of the particular user's device, such as their computer or cell phone.

In general, various rules and rule sets may be implemented in conjunction with administering the group account. One aspect of the rule set may include access control. Other rules may control the availability of particular functionality to particular users at particular times, based on particular parameters, for example. A rule set may be crafted for the particular situation in which the group account is to be used.

In accordance with further aspects of the invention, the invention provides various tracking features. Specifically, the banking platform, that supports the group account, may track various parameters associated with the group account including—tracking deposits and withdrawals of the group account; balance information of the group account; and access to the group account including who accessed particular information and when, for example. Also, the invention may provide for enhanced input (scanning) and tracking of checks, receipts, and other documentation associated with the group account.

The group account may be associated with any number of users. In turn, each user may be associated with a respective GA Card. Each GA Card may be in the form of a credit card, debit card, or stored value card, for example. Each card may be exclusively associated with a particular individual in the particular group. Alternatively, each card may be associated with a portion of the group, e.g. such as a particular family. Various other demarcations are possible. Alternatively, the group account may provide for cardless users, i.e., without a physical card but rather based solely on credentials provided to the particular user. Relatedly, a user might interface with the group account via a variety of channels, such as using an ATM, going to a branch (i.e., a physical branch office of the bank) or interfacing on-line, for example. Specific tracking capabilities may be provided to track activity of users on an individual basis. Relatedly, various reports may be crafted and created for particular situations. For example, a report may be generated based on each player on the team or each team in the club, for example, and show such particulars as funds contributed, timing parameters, progress percentages, and other parameters. The invention provides the advantage of transparency, in a controlled manner, of transactions associated with the group account. The invention may further be used in conjunction with P2P (person to person) transactions.

Administration of the group account and associated cards may be performed by a suitable banking entity. Various fees may be implemented in conjunction with the group account. For example, there may be a $1 monthly fee associated with the group account, with $1 additional for each card associated with the account, unless the average balance is greater than $500, in which case the fees are waived. Various other fee arrangements are of course possible with thresholds as desired.

Administration of the group account may be provided such that the group account is easy to setup (open) and easy to close via a website, for example. The invention provides for various linking of the group account. For example, to enhance ease of group account setup, the group account may be linked to a particular user's permanent account. Such permanent account of the user might be relied upon for personal information and for overdraft protection of the group account. Relatedly, the group account may provide for accumulated funds to be automatically transferred to the user's permanent account in some automated, and documented manner. For example, such a transfer might occur upon a particular external event, in a particular time frame, and/or upon a particular threshold being attained (such as a particular balance being attained). In one embodiment, upon the expiration of the group account, all funds would transfer to a particular permanent account, to which the group account was linked.

The group account may utilize direct deposit account processing; person to person (P2P) processing, bill payment processing, and other known processing. In one embodiment, the group account may be used in conjunction with (and linked to) social media sites, such as FACEBOOK. Such conjunctive use may include setting up the group account, payments, securing information about the group account, and various other processing, as desired.

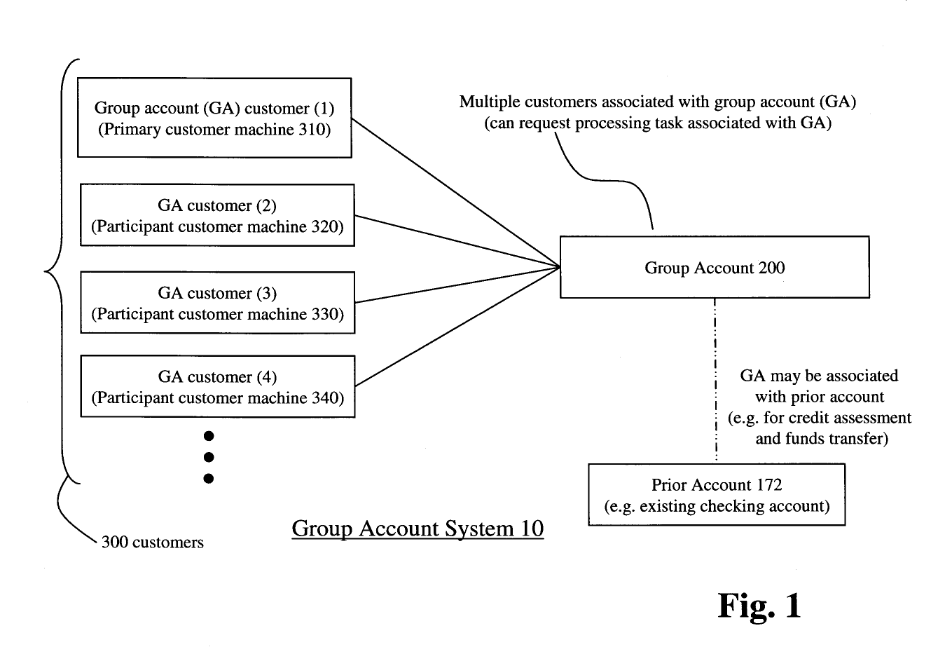

FIG. 1 is a schematic diagram showing a group account system 10, in accordance with one embodiment of the invention. The group account system 10 may perform the various features as described herein. As shown, the group account system 10 includes a plurality of customer machines 300, i.e., computers. Each of the customer machines 300 provides an interface such that a human customer may interface with a group account 200 to which they are associated. In particular, using a respective customer machine 300 a customer may provide credentials to a bank platform, i.e., a bank computer system, so as to access the group account 200. Such access might, for example, allow the customer to deposit and debit funds from the group account 200. As shown in FIG. 1, the group account 200 may be associated with a prior account 172, i.e., such as a permanent account as described above.

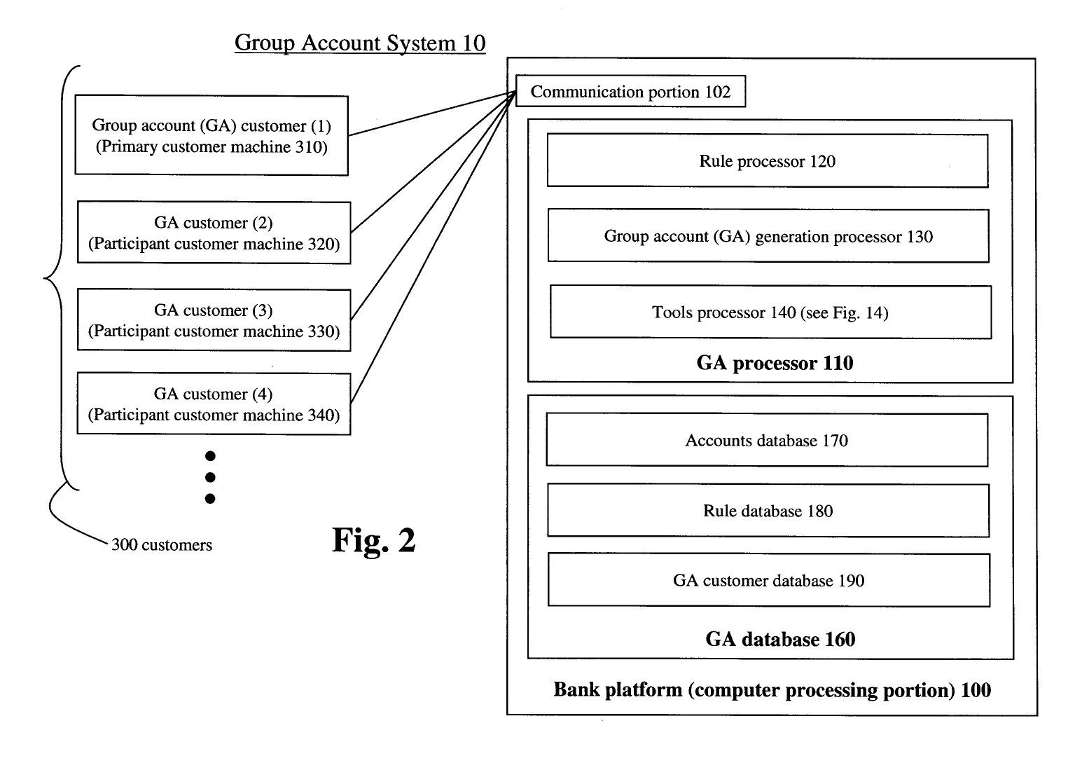

FIG. 2 is a block diagram showing further details of a group account system 10, in accordance with one embodiment of the invention. As shown, the group account system 10 includes a bank platform 100. The bank platform 100 may be in the form of a computer processing portion that is maintained by a bank entity. The bank platform, i.e., banking platform, 100 includes a communication portion 102 that provides various communications between the bank platform 100 and outside processing portions, such as the customer machines 300, as well as other banking entity's processing systems for example. The bank platform 100 also includes a group account (GA) processor 110 and a group account (GA) database 160.

The GA processor 110, disposed in the bank platform 100, handles a variety of processing performed in operation of a group account. The GA processor 110 includes a rule processor 120. In accordance with one embodiment of the invention, the rule processor 120 inputs various parameters associated with customer's requested processing task, and based on associated rules, provides certain processing options. For example, the rules may dictate what operations are available to a particular customer based on the credentials of the customer.

The GA generation processor 130 also includes a GA generation processor 130. The GA generation processor 130 generates a group account in response to a request from a customer.

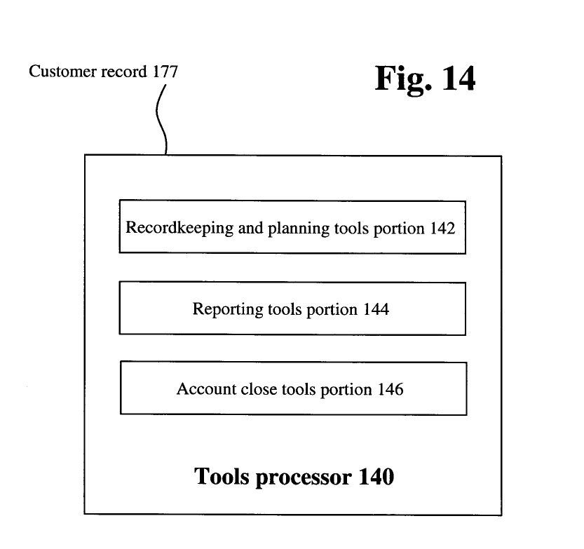

The GA processor 110 further includes a tools processor 140. Further details of the tools processor 140 are shown in FIG. 14. As shown, in FIG. 14, the tools processor 140 includes a record keeping and planning tools portion 142, a reporting tools portion 144, and an account close tools portion 146. The record keeping and planning tools portion 142 provides various functionality to keep records associated with activity of the group account and to perform planning tools for the group account. For example, the planning tools might include functionality to forecast a fund raiser or perform budgeting, for example. The reporting tools portion 144 may report various activity of the group account as described herein, including generating a statement or report based on the activity of the group account and/or based on data processed by the record keeping and planning tools portion 142. The account close tools portion 146 may include a processing portion that performs various functionality associated with close of the group account, as described herein. Further details are described below. The GA database 160 is a database that stores various data, i.e., information, that the GA processor 110 either uses or generates. The accounts database 170 stores various account information, such as group account information, as well as other account information. The rule database 180 stores the various rules used by the rule processor 120. The GA customer database 190 stores various customer information, such as customer credential information.

As shown in FIGS. 1 and 2, the customer machines 300 may be comprised of both a primary customer machine, as well as a participant customer machine, in accordance with one embodiment of the invention. In such embodiment, the primary customer machine is associated with a primary customer who is the main contact for a particular group account. For example, the primary customer may be the customer who initially set up the group account. Accordingly, the primary customer might be provided credentials allowing the highest level of access to the group account. On the other hand, the participant customers might be provided lower access rights and/or access rights of varying degree.

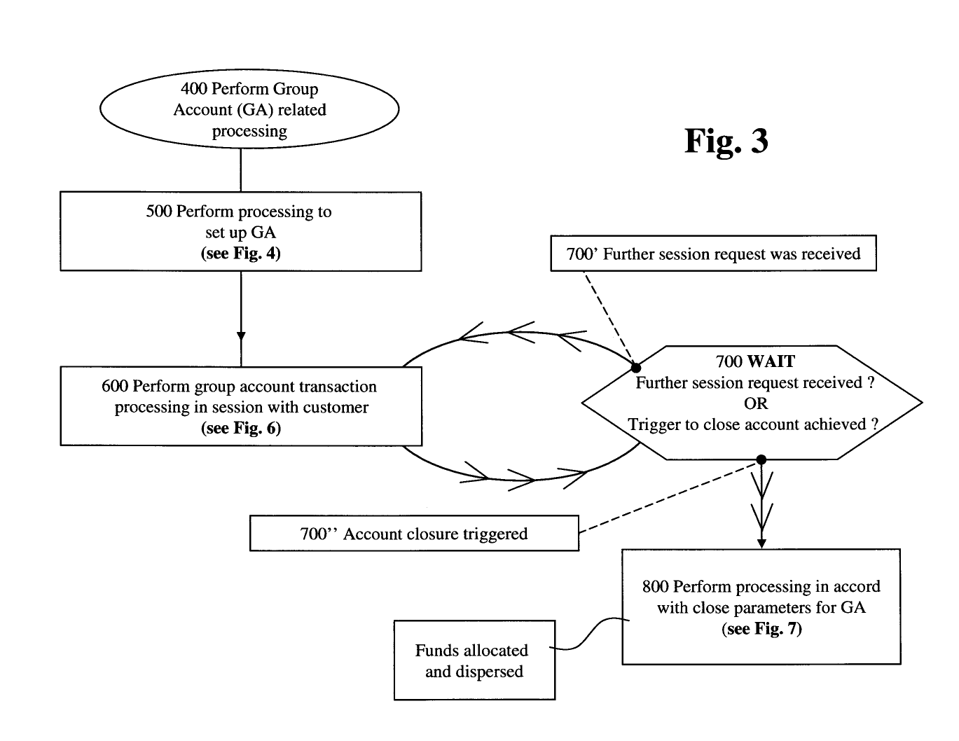

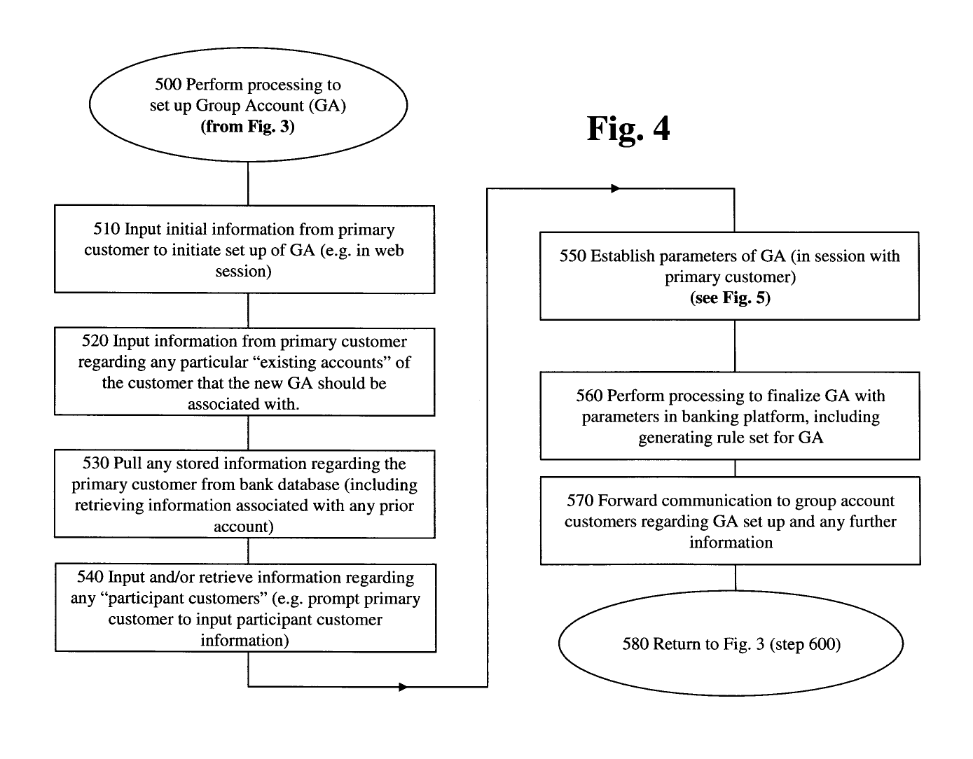

FIG. 3 is a high-level flowchart showing aspects of group account (GA) related processing in accordance with embodiments of the invention. The related flowcharts of FIGS. 4-7, described below, illustrate further aspects of group accounts and related processing.

As shown, the process of FIG. 3 starts in step 400 and passes to step 500. In step 500 of FIG. 3, processing is performed to set up the group account. Further details of the processing of step 500 are shown in FIG. 4 and described below. After step 500 of FIG. 3, the process passes to step 600. In step 600, group account transaction processing is performed in a session with a customer. For example, using a web browser, the customer might log on to a server (of the bank platform 100) that provides the various financial related processing in conjunction with the group account. However, various other types of sessions are possible depending on the type of interface provided by the bank platform. For example, rather than a session over the internet via a customer's browser interfacing with a server, in alternative embodiments, the customer might conduct a session using a bank ATM machine that interfaces with the bank platform. The interface between the customer and the bank platform may be performed using any of a wide variety of technologies.

With further reference to FIG. 3, after the group account transaction processing is performed in a session with a customer, the process passes to step 700. Step 700 of FIG. 3 shows “wait” processing. Specifically, step 700 shows that the bank platform 100 waits for a further event to prompt further action. For example, the bank platform may wait for a further session request to be received, i.e., such as the customer logging in to the bank platform for a further session. Upon the further session being requested by the customer, the process passes back to step 700 as reflected in step 700′, as shown in FIG. 3. On the other hand, a particular event to trigger the close of the group account may be achieved as shown in step 700″. In the situation that a trigger event is indeed achieved, the process passes from step 700 to step 800.

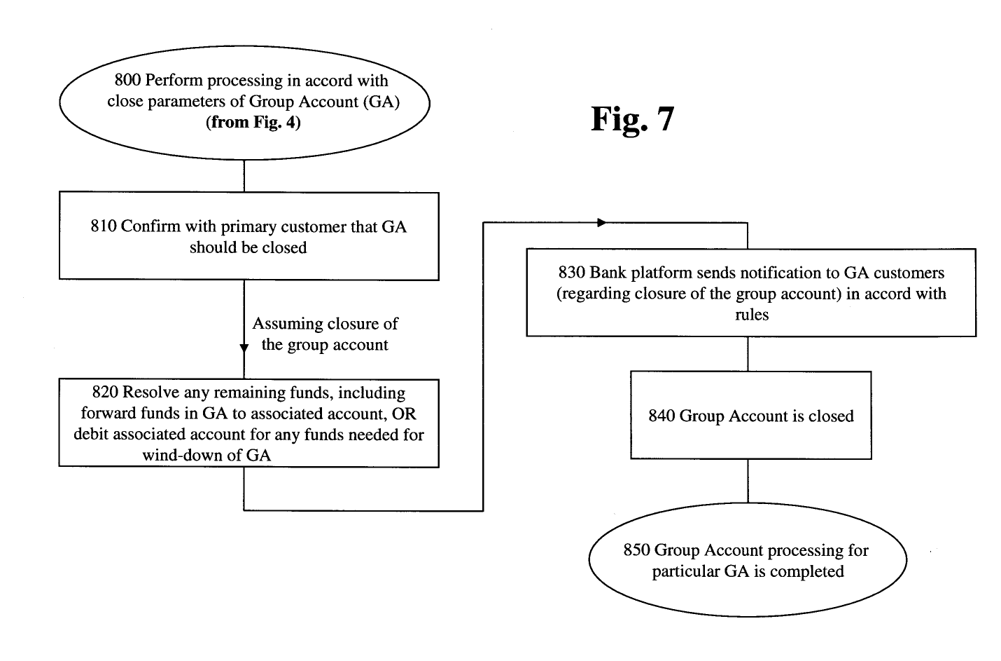

As reflected in step 800 of FIG. 3, processing is performed to close the account. Such closure of the account may be performed in accord with previous parameters selected by the customer, as described herein, or as dictated by the bank. The close of the group account may include an allocation and disbursement of funds in the group account. Further details of closure of the account are shown in FIG. 7 and described below.

FIG. 4 is a flowchart showing in further detail the “perform processing to set up group account” processing of step 500 of FIG. 3 in accordance with one embodiment of the invention. As shown in FIG. 4, the processing starts in step 500 and passes to step 510. In step 510, the bank platform 100 inputs initial information from a customer to initiate set up of a group account, such as in a web session as described above. For example, step 510 might include the customer logging in to the bank platform using a user name and password for an existing account. In the various menu options provided to the customer, a “set up group account” option, or similarly named option, might be included in the menu. As the customer who sets up the group account, such customer is herein characterized as the “primary customer” in accordance with one embodiment of the invention.

After step 510, the process passes to step 520 of FIG. 4. In step 520, the bank platform inputs information from the primary customer regarding any particular existing accounts of the customer that the new group account should be associated with. In one embodiment of the invention, if the customer came into the bank platform via an existing account, that information regarding that existing account may be automatically associated with the group account that the customer is currently setting up. However, it may be the situation that the customer has other accounts with the bank to which the group account should be associated. Alternatively, it may be the situation that the customer engaged in a session (with the bank platform) separate and apart from any existing account that the customer has with the bank. In such scenario, the bank platform collects all new information from the customer.

After step 520, the process passes to step 530. In step 530, the bank platform pulls any stored information (regarding the primary customer) from the bank database. Such retrieval of data may, for example, constitute retrieving information associated with any prior account that the customer has identified. However, it may be the situation that other data may also be collected regarding the customer. After step 530, the process passes to step 540.

In step 540, information regarding what is herein characterized as “participant customers” is collected. To explain, the processing of steps 510, 520, and 530 relate to the “primary customer” in that such customer is the customer who is setting up the group account, working with the particular bank. Step 540 of FIG. 4 reflects that such primary customer is then prompted to input information regarding “participant customers.” Such participant customers are other persons (who may or may not be customers of the bank) who are to be associated with the particular group account. As discussed further below, such participate customers typically have varying levels of access to the group account, i.e., access relating to information and functionality, for example. In accordance with one embodiment, the primary customer might input each participant customer's first and last name, as well as their email address. Thereafter, the bank platform may communicate with the such participant customers including contacting the participant customers via the provided email address, advising the participant customers of the group account and their access rights to the group account, and setting up credentials with each respective participant customer such that each participant customer may access the group account in the future, for example. It is of course appreciated that other information may be provided to the participant customer and/or collected from the participant customer as desired.

Accordingly, after the bank platform has collected the participant customer information (from the primary customer) in step 540, the process passes to step 550.

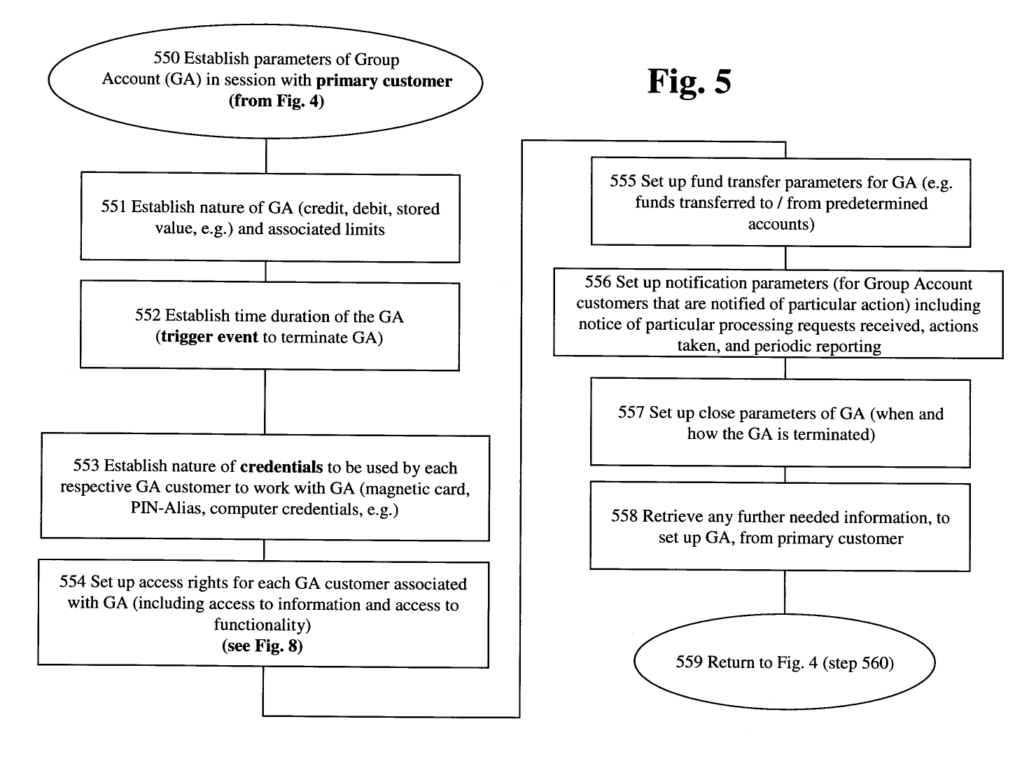

In step 550, the processing, as performed by the bank platform 100 in this embodiment, establishes the parameters of the group account. In the embodiment reflected in step 550 of FIG. 4, this is also performed while still in the session with the primary customer (in setting up the group account). Further details of the processing of step 550 are described below and shown in FIG. 5. After step 550, the process passes to step 560. In step 560 of FIG. 4, further processing is performed to finalize the group account by establishing a rule set for the group account. The generation of the rule set may be based on parameters that were established in step 55.

Then, in step 570, the bank platform forwards a communication to each group account customer regarding set up of the group account and any further information to be provided to the group account customers, i.e., including the primary customer, as well as the participant customers.

After step 570 of FIG. 4, the process passes to step 580. In step 580, the process returns to FIG. 3 and step 600.

FIG. 5 is a flowchart showing in further detail the “establish parameters of group account in session with primary customer” processing of step 550 of FIG. 4 in accordance with one embodiment of the invention. Accordingly, FIG. 5 reflects processing, in this embodiment, performed in the initial session with the primary customer to set up the group account. As shown in FIG. 5, the processing starts in step 550 and passes to step 551.

In step 551 of FIG. 5, the bank platform establishes the nature of the group account and associated limits. For example, the bank platform interfacing with the primary customer, sets up whether the group account will be a credit account, debit account, stored value account, or any other account type which may be provided to the primary customer as an option. Further, step 551 may include the establishment of limits to the group account, such as a credit limit. After step 551, the process passes to step 552. In step 552, the bank platform interfaces with the primary customer to establish the time duration of the group account. In other words, step 552 reflects the establishment of a trigger event that will terminate the group account. The trigger event might be a particular date from initial set up of the group account. Alternatively, or in addition to, the trigger event might be the achievement of a particular monetary amount in the group account. It is appreciated that a wide variety of trigger events may be utilized in conjunction with the invention. For example, the processing of step 552 might establish that the group account will terminate, i.e., be closed, upon the earlier of 6 months from set up of the group account or the achievement of $1,500 in the group account.

After step 552 of FIG. 5, the process passes to step 553. In step 553, the processing establishes the nature of the credentials to be used by each respective group account customer, i.e., what credentials will the primary customary as well as all the participant customers use to access the group account. For example, establishment of the credentials might include the bank platform (1) dictating or (2) receiving information from each customer regarding whether that customer will use a magnetic card, a PIN (personal identification number) alias, computer credentials, and/or any other type of credential as desired. In accordance with one embodiment of the invention, the primary customer, in the initial set up session, inputs information to select the credentials that each participating customer will be provided with. After step 553 the process passes to step 554.

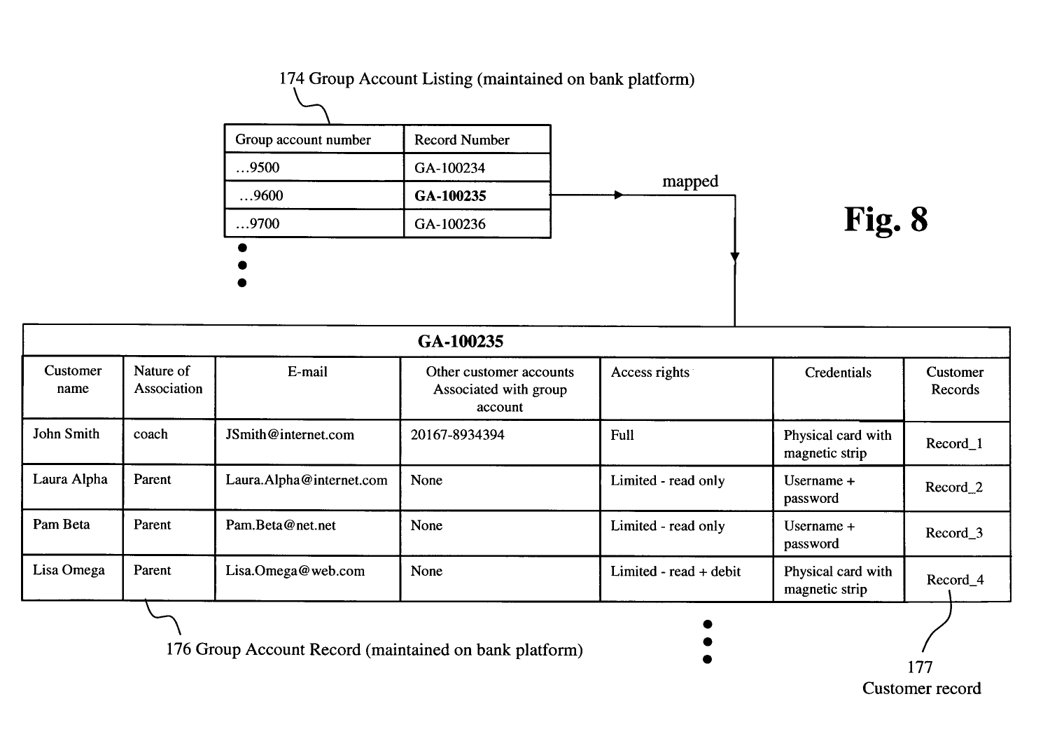

In step 554 of FIG. 5, the bank platform 100, interfacing with the primary customer, sets up access rights for each group account customer associated with the group account. That is, in this embodiment, the primary customer sets up the access rights for both himself as well as all the participant customers. Such access rights include access to information as well as access to functionality. For example, the primary customer might be the coach of a soccer team and provide himself with the most, i.e., full access to the group account. Further, the primary customer may know (at that point in time) which other parent (a participant customer) will be acting in the capacity as treasurer of the soccer team. Accordingly, the coach (the primary customer) will provide the treasurer with expansive access to the group account, albeit, perhaps not as expansive as the primary customer. Other parents, i.e., other participant customers, may be provided access to varying degrees. For example, an assistant coach (a participant customer) might be provided more limited access than the treasurer. Further, other parents (participant customers) may be provided even less access. It should be appreciated that the access provided to a particular primary customer and participant customer may vary widely as desired. FIG. 8 is a diagram showing an example of access rights vis-à-vis a primary customer and a plurality of participant customers, as described further below.

With further reference to FIG. 5, after step 554, the process passes to step 555. In step 555, the bank platform sets up the fund transfer parameters for the group account, i.e., the manner in which funds will be transferred to or from predetermined accounts. In this processing, the bank platform 100 interfaces with the primary customer to set up such parameters. After step 555, the process passes to step 556.

In step 556, the bank platform interfacing with the primary customer, sets up notification parameters for the group account customers, i.e., what customer's are to be notified of what actions dealing with the group account. Such notice might include notice of particular processing requests that are received, actions taken in response to such requests, and/or periodic reporting such as balance information, deposit information in general, and/or debit information in general.

After step 556, the process passes to step 557. In step 557, the bank platform interfacing with the primary customer sets up close parameters of the group account, i.e., when and how the group account is to be terminated.

Then, in step 558, the bank platform retrieves any further information, needed to set up the group account from the primary customer and performs any further processing needed to set up the group account. After step 558, the process passes to step 559.

In step 559, the process returns to FIG. 4 and step 560.

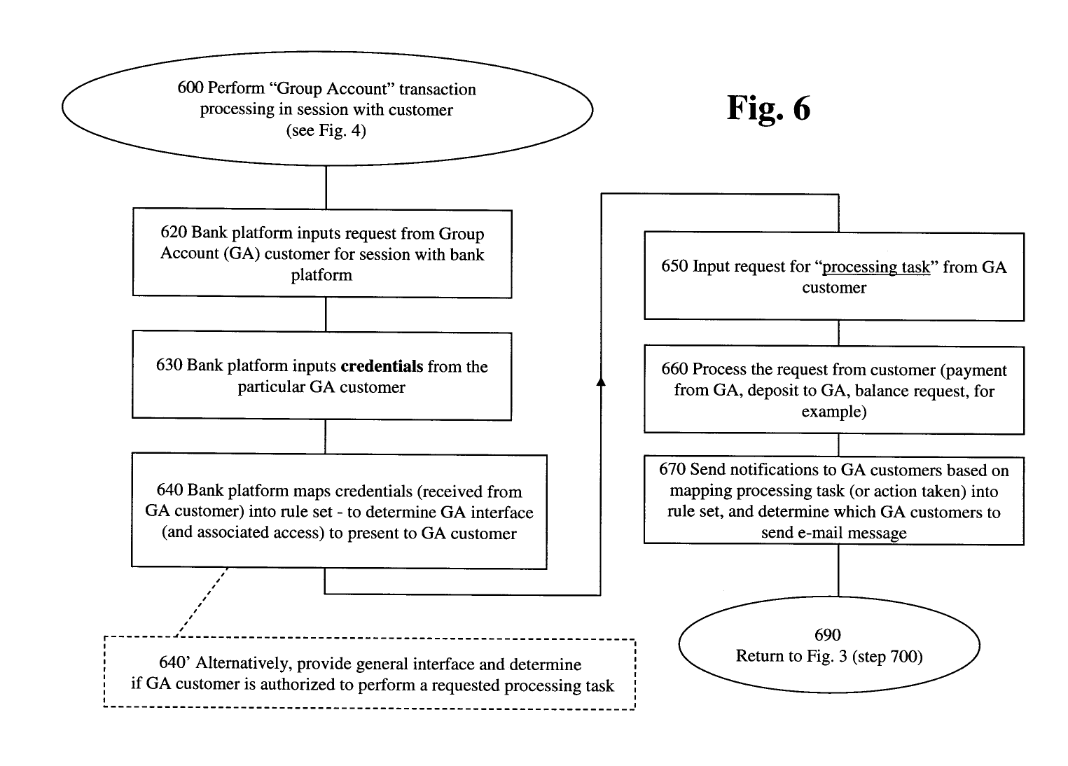

FIG. 6 is a flow chart showing in further detail the “perform ‘group account’ transaction processing in session with customer” processing of FIG. 4, in accordance with one embodiment of the invention. Accordingly, FIG. 6 shows processing performed after the group account is set up (by the primary customer) in normal operation of the group account. For example, the processing of step 600 might be a participant customer logging into the bank platform 100 in a web session (to interface with a bank platform) in order to secure the balance of the group account. As illustrated in FIG. 6, after step 600, the process passes to step 620.

In step 620 of FIG. 6, the bank platform inputs a request from a group account customer for a session with the bank platform, such as a group account customer logging into the bank platform 100 using an Internet browser on a personnel computer. Step 630 reflects that the bank platform inputs credentials from that particular group account customer. After step 630, the process passes to step 640.

In step 640 of FIG. 6, the bank platform 100 maps the credentials (received from the particular group account customer) into a rule set. As a result of such mapping, the bank platform determines the particular graphical user interface (GUI) to generate and present to the customer, and the associated access provided by that GUI. For example, if a session with the primary group account customer (with full access), then the presented GUI might include a balance transfer menu option, a balance menu option, as well as various other option. However, with a participant customer, the GUI may not include the balance transfer menu option, i.e. in that such participant customer does not have access to make balance transfers.

Alternatively, as shown in step 640′ of FIG. 6, the bank platform 100 might provide the same general interface to all group account customers and upon receiving a particular request from a group account customer (in a session with that group account customer), the bank platform determines if the particular customer is indeed authorized to perform the requested processing task. If the customer is authorized, the bank platform performs the processing task as requested. If the particular customer is not authorized, then the bank platform would advise the customer of such disposition.

After step 640 of FIG. 6, the processing passes the step 650. In step 650, the bank platform inputs a request from the group account customer for a particular processing task. Then, in step 660, the bank platform performs processing via request from the customer, such as payment from the group account, deposit to the group account or a balance request associated with the group account, for example.

After step 660, the process passes to step 670. In step 670, the bank platform sends notifications to the group account customers based on mapping the processing task into a rule set and determining which group account customers to send email messages regarding the processing task. After step 670, the process passes to step 690. In step 690, the processing returns to step 700 of FIG. 6.

FIG. 7 is a flowchart showing in further detail the “perform processing in accord with close parameters of the group account in accordance with one embodiment of the invention. The process of FIG. 7 starts in step 800 and passes to step 810. In step 810, in accordance with one embodiment of the invention, the bank platform confirms with the primary customer that the group account should be closed. However, in accord with other embodiments, the processing may not include a requirement that confirmation be received in order to close the account. In general, various rules may be implemented in conjunction with closure of the group account as desired. For example, the occurrence of some triggering events may result in the primary customer being required to confirm closure of their group account. On the other hand, the occurrence of other triggering events may result in the closure of the group account without confirmation by the primary customer. Other rules may be in place such as providing the primary customer with a preset time window in which to confirm closure of the account, i.e., the primary customer has 3 days to confirm closure of the group account. In one embodiment, if the primary customer does not confirm closure of the group account, then the group account will remain open. However, in other embodiments, in the absence of the primary customer's confirmation of closure of the group account, then the group account will proceed with closure. It is appreciated that various other rules, i.e., protocols, may be implemented as desired. After step 810 of FIG. 7, the processing passes to step 820, i.e., assuming closure of the group account.

In step 820, the bank platform 100 resolves any remaining funds left in the group account, such as forwarding funds in the group account to an associated account, such as a permanent account of the primary customer. Alternatively, it may be required to debit an associated account (of the primary customer, for example) for any funds needed for close of the group account. After step 820, the process passes to step 830.

In step 830, the bank platform sends notification to the group account customers in accord with the rules in place. In accordance with one embodiment of the invention, the primary customer as well as all the participant customers are sent notice of the closure of the group account. After step 830, the process passes to step 840.

In step 840, the group account is formally closed. Step 840 of FIG. 7, as well as step 830) may include any of a variety of known actions and/or known notifications, for example, that are typically associated with closure of a financial account.

Step 850 of FIG. 7 reflects that the group account processing for that particular group account is completed.

FIG. 8 is a diagram showing a group account listing 174 and an associated group account record 176 in accordance with one embodiment of the invention. The group account listing 174 and the group account record 176 may both be disposed in the accounts database 170 in the bank platform 100. The group account listing 174 is a data set containing various group accounts that are maintained by the bank platform 100. The group account listing 174 includes the respective group account numbers, as well as the particular record number that is associated with the particular group account.

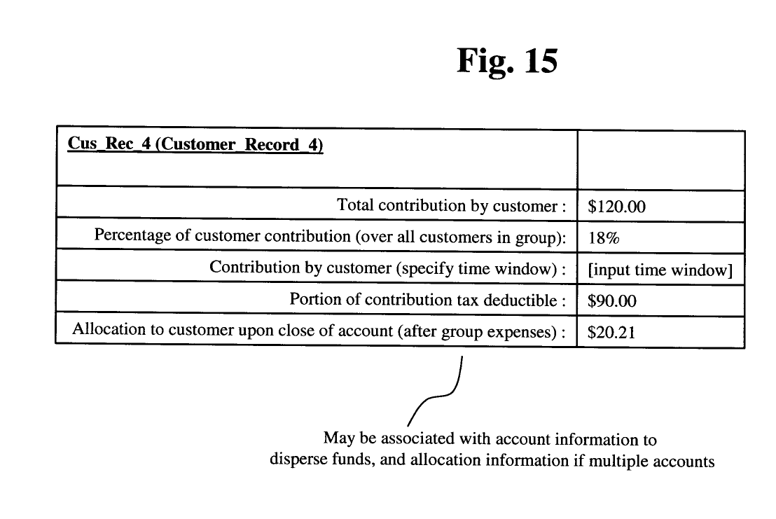

The record number (in the group account listing 174) is associated, i.e., mapped, to the actual group account record 176. Accordingly, the group account record 176 contains the various information that is used by the bank platform 100 in maintaining the group account. As shown in FIG. 8, the group account record 176 includes the various group account customers, the nature of each customer's association to the group account, e-mail or other contact information for each customer, other accounts of each customer that have been identified to be associated with the group account, access rights of each customer, the particular credentials that each customer will use in conjunction with the group account (i.e., a particular customer might use a physical card with a magnetic strip or a username+password, for example), as well as a customer record 177 for each group account customer. Further details are described below, and in particular, further details of the customer record 177 are described below with reference to FIG. 15.

As described herein, various data may be input, processed by, and output by the GA processor 110. Illustratively, the record keeping and planning tools portion 142 may track a variety of parameters, and input information as needed to perform such tracking. Relatedly, FIG. 15 is a table showing a customer record 177, in accordance with one embodiment of the invention. The customer record 177 includes parameters that may be tracked, including the total contribution by customer; the percentage of customer contribution (over all the customers in the group); the contribution by the customer for a specific time window (e.g. a report might be generated showing contributions of the customer over a particular soccer season, such as September 1 to November 30); and the portion of the contribution that is tax deductible, exempt, or subject to some other tax status. Further, the portion 142 may track data so as to provide allocation of funds in the group account—upon close of the group account. Various other parameters may be tracked and reported, as desired.

Regarding allocation to a customer upon close of the group account, the portion 142 and/or the account close tools portion 146 may include functionality to perform a variety of tasks. For example, upon opening a group account, the customers may be provided with different options of how the group account is to be terminated. One option might be to disperse the funds evenly between all the group account customers, after all expenses of the group are paid out. Another option might offer adjustments in the allocation of funds upon close of the group account. Such adjustment might be based on money contributions to the group account, i.e., disbursement is based pro rata on how much each customer contributed. The adjustment might be based on other criteria, such as non-monetary contributions.

Relatedly, the record keeping and planning tools portion 142 may track parameters associated with any deposit or withdrawal from the group account. For example, if a particular deposit is made electronically, then the record keeping and planning tools portion 142 may retrieve the associated data and store such in the customer record 177. If cash is collected by the primary customer, for example, then the primary customer may deposit the cash into the group account. However, in conjunction with the deposit, the record keeping and planning tools portion 142 may require that the customer input information documenting the source of the cash. In other words, the tools processor 140 may provide a processing layer over transactions to and from the group account, so as to document such transactions. The content of such documentation may vary as desired. In particular, the documentation required by the tools processor 140 may well exceed that required in a typical every day transaction. In accordance with one embodiment of the invention, such required documentation, i.e., the level of documentation, might be varied by the primary customer, or other person.

The reporting tools portion 144 may then report any collected information and stored information as desired.

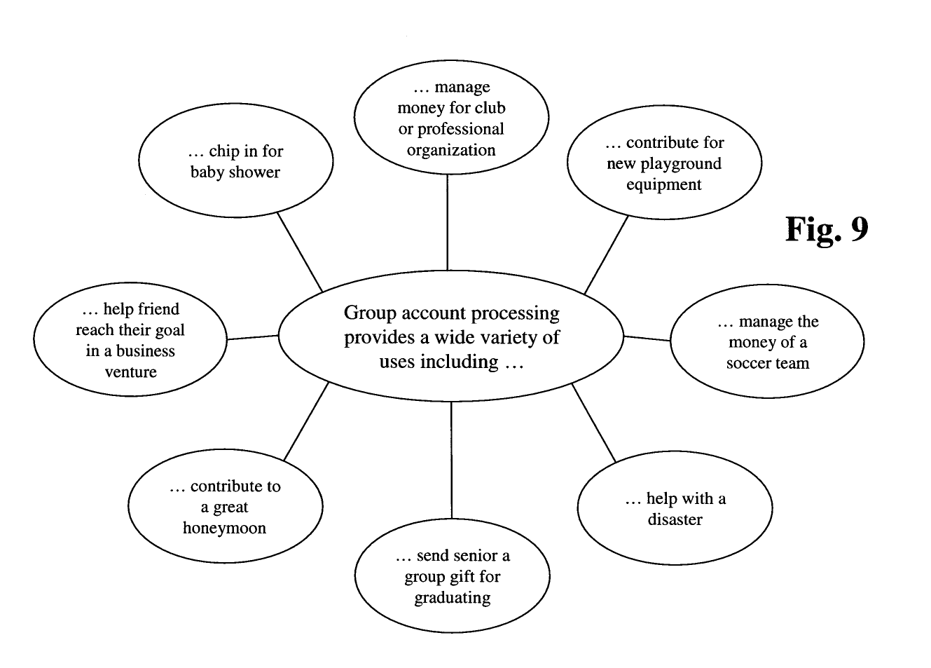

It is appreciated that the processing described above may be utilized in a wide variety of contexts. FIG. 9 is a diagram illustrating examples of the group account processing described herein, in accordance with embodiments of the invention. Such uses include, for example, managing money for a club or professional organization, a group of parents contributing for the cost of new playground equipment; to provide a treasurer parent the tools to manage the money of a soccer team; to help with the disaster; for a group of friends to send a senior a group gift for graduating; for a group of friends to contribute to a honeymoon; to help a friend reach their goal in a business venture; and to chip in for a baby shower. It is of course appreciated that a wide variety of other uses are possible.

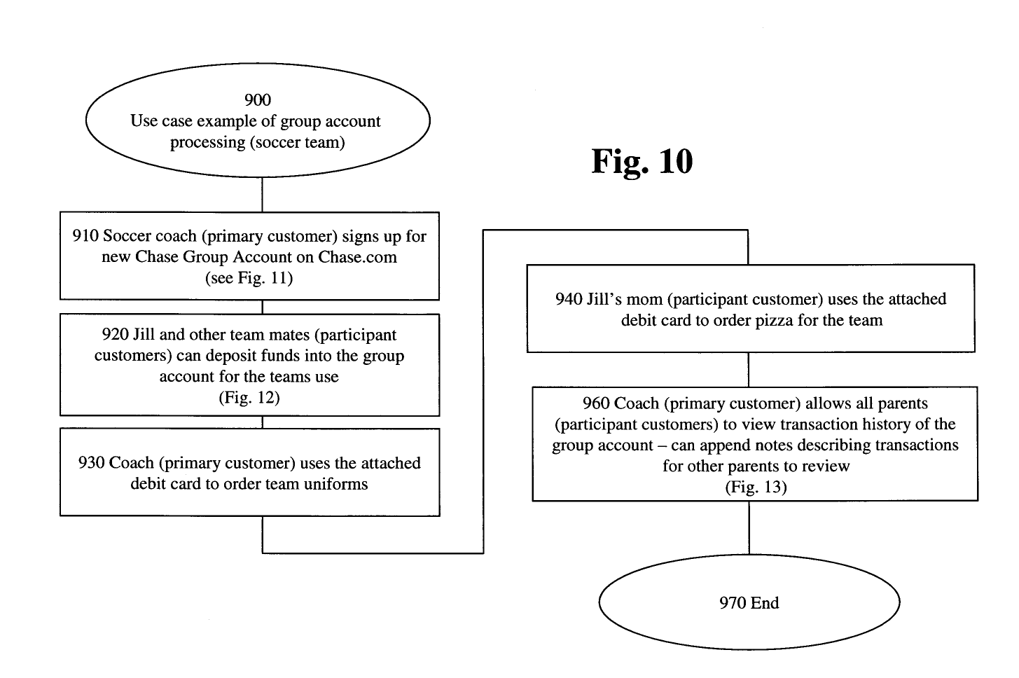

FIG. 10 is a flowchart showing a use case example, relating to a soccer team, of the group account processing in accordance with one embodiment of the invention. The processing of FIG. 10 starts in step 900 and passes to step 910.

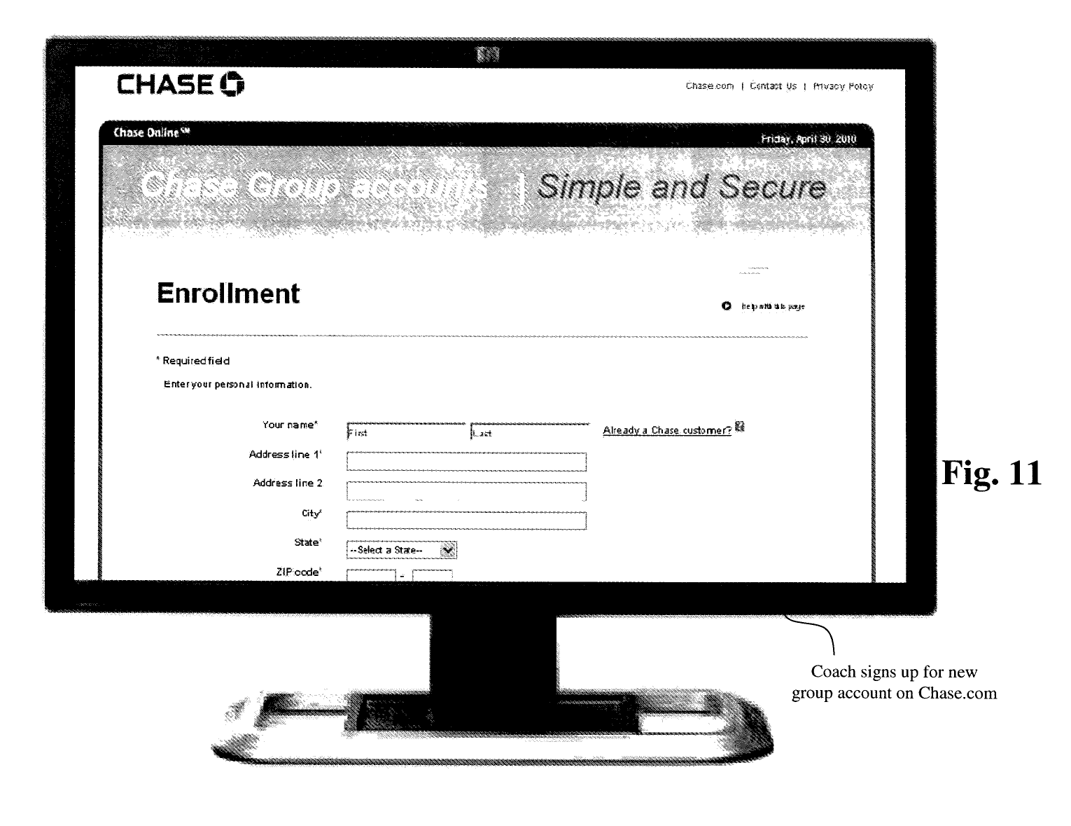

Step 910 illustrates that the soccer coach (the primary customer in this example) signs up for new Chase Group Account on Chase.com. FIG. 11 shows an illustrative graphical user interface (GUI) that may be generated by the bank platform 100 and displayed on the customer's computer in accordance with one embodiment of the invention. As described above, it may the case that the customer is a new customer to the particular bank (in which case all needed information is collected from the customer for the first time). On the other hand, it may be the case that the customer already has an account with the particular bank, in which case information associated with such prior account may be used for the new group account. Use of such existing information (in the bank platform 100) may for example include: the population of a new record for the group account, or alternatively, a linking or other association of the existing information to the new group account.

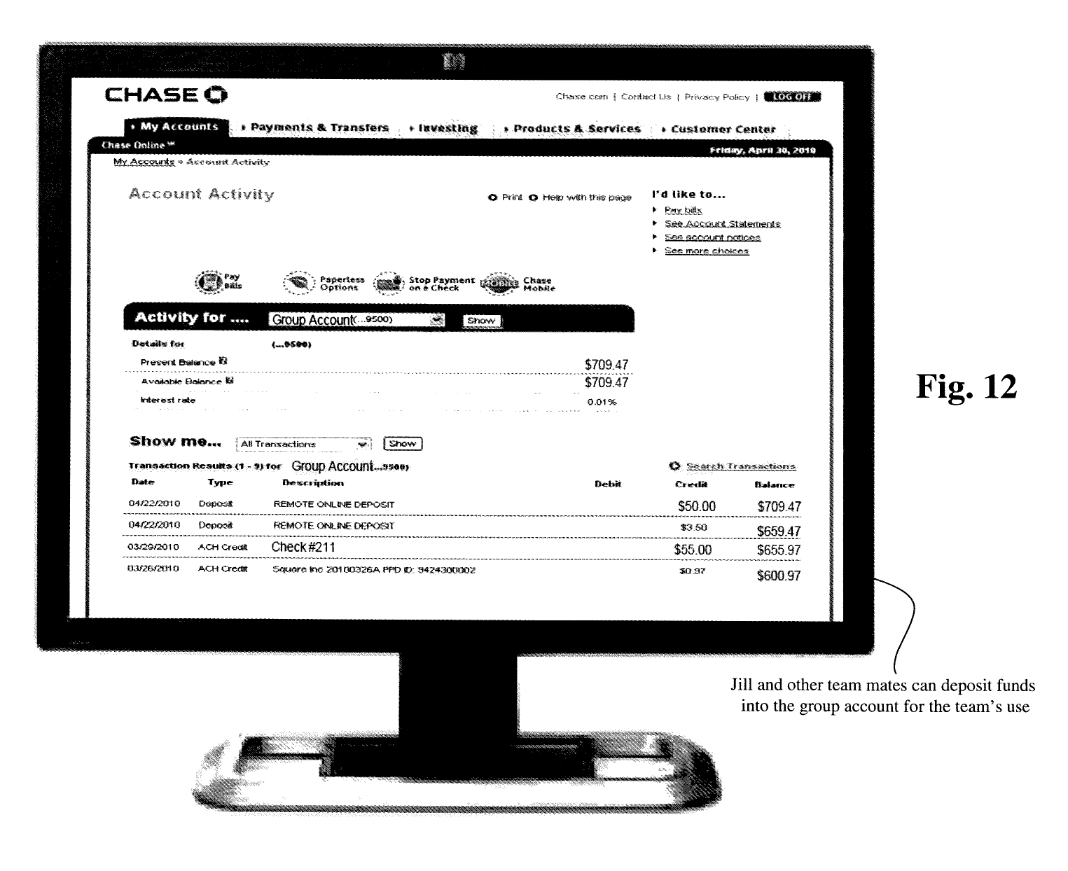

Step 920 of FIG. 10 illustrates that Jill and other team mates (i.e., the participant customers in this example) can deposit funds into the group account for the team's use. Relatedly, FIG. 12 shows an illustrative graphical user interface (GUI) that may be generated by the bank platform 100 and displayed on the customer's computer in accordance with one embodiment of the invention, i.e., on Jill's computer. The GUI of FIG. 12 shows various options available to the participant customer including: account statements, account notices, previous balance information, available balance information, interest rate, and transaction details, for example. Various other information may also be provided to the customer as desired. However, in the GUI of FIG. 12, balance transfer functionality is not provided, in this example, since FIG. 12 is a GUI for a participant customer.

Steps 930 and 940 illustrate further uses of the particular group account. In step 930, the coach (the primary customer) uses a debit card (provided to the coach in conjunction with opening the group account) to order team uniforms. In step 940, Jill's mom (a participant customer) uses her debit card (provided in conjunction with opening the group account) to order pizza for the team.

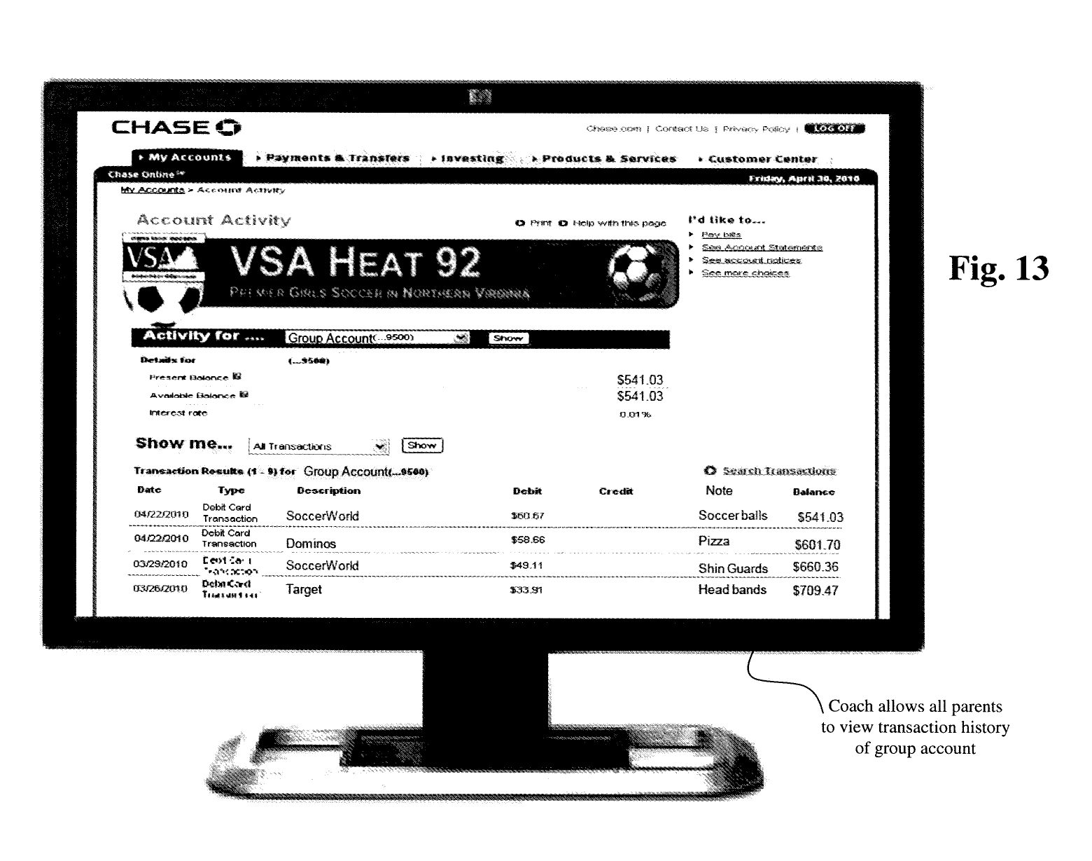

Step 960 and FIG. 13 show further aspects of the group account in accordance with embodiments of the invention. That is, as illustrated by step 960, the coach (the primary customer) has allowed all parents (participant customers) to view transaction history of the group account. Further, each of the participant customer's can append notes describing transactions for other parents to review.

As set forth herein above, it is appreciated that various processing is described as performed by the bank platform 100. However, it is appreciated that such processing may alternatively be preformed by a further system that works with the bank platform to perform the various processing. In particular, some of the processing described above may be performed by a processor and/or server, for example, sitting in front of the bank platform. Relatedly, various of the communications described herein, such as communications to and from the customer may flow through other systems. As described above, in one embodiment, the primary customer of a particular group account is authorized to perform activities such as deposit funds, withdraw funds, or secure statements of the account for example. On the other hand, a parent user (or participant customer) is provided with less access—such that the parent may only make deposits and view the current balance of the account, for example. However, it is appreciated that persons involved with a particular group account may change over time, including both primary customers, as well as participant customers. Relatedly, the GA processor 110 may be provided with functionality to change to a new primary customer. That is, the tools processor 140 may be provided with a tool such that Joanne Smith is designated as the current primary customer, and that Laura Alpha is designated as the “backup primary customer.” Upon Joanne Smith's departure from the group account, if such indeed occurs, the processing may provide for either Joanne or Laura to log into the GA processor 110 to advise of the change. Such backup primary customer may be designated at any point in the life of a group account, such as upon the opening of the group account or upon the primary customer's departure from the group account.

Relatedly, the GA processor 110 may be provided with functionality to require two (or more) persons to perform certain actions, i.e., require multiple authorizations. This might be the case with a particularly large transaction, closing down the account, or other notable actions. In accordance with one embodiment of the invention, the GA processor 110 may input a request for a particular notable action from one customer (e.g. the primary customer), and then send a communication to the backup primary customer asking for confirmation. Accordingly, the GA processor 110 may require such multiple authorization from two particular persons (e.g., the primary customer and backup primary customer), or alternatively might require such multiple authorization from any two, or more, persons. For example, to close the group account, the GA processor 110 might require authorization from more than two group account customers. In accordance with further aspects of the invention, the group account may utilize known technology such as direct deposit accounts and other account mechanisms. For example, the “group account,” as described herein, might in one embodiment be constituted by a plurality of accounts. One account might be in the form of a deposit only account. Account information for such account could be relatively freely given out, since the account information (given out) would not allow withdrawals. Funds in the deposit only account might be periodically transferred to a standard checking account. Access to such checking account may then be controlled as described herein.

In accordance with some embodiments of the invention, it is appreciated that the group account as described herein may be comprised of a plurality of accounts, as described above. Further, such plurality of accounts may be organized in a hierarchical manner, either from the perspective of access to the group account or in some other manner. For example, there may be a master group account with sub group accounts. The primary customer of the master group account is also a primary customer on all the sub group accounts, and in addition, each of the sub group accounts has a respective primary customer, for example. In this manner, each of the sub group accounts has two (2) primary customers, as well as the various respective participant customers. Funds as well as various information associated with such funds, may flow from the master account to the subaccounts (or vice-a-versa) in some manner. For example, the flow of funds and/or information might be based on a suitable rule set.

Hereinafter further aspects of implementation will be described.

As described above, embodiments of the system of the invention and various processes of embodiments are described. The system of the invention or portions of the system of the invention may be in the form of a “processing machine,” i.e. a tangibly embodied machine, such as a general purpose computer or a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the group account system 10 described above, executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform. It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example. As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A method to provide a group account in the form of a financial fund and maintained by a financial entity, the method implemented by a tangibly embodied computer processing system, the group account maintained on the computer processing system, the method including:
maintaining, by the computer processing system, the group account, the group account associated with a plurality of customers who each have selective access to the group account, such selective access determined by a rule set disposed in the computer processing system, each of the plurality of customers having an interest in the group account, the group account constituted by a single account in the form of a single financial fund; and
the computer processing system:
receiving credentials from one of the plurality of customers in a session;
comparing the input credentials with the rule set to determine access to the group account to be provided to the customer, wherein the input credentials are mapped to the rule set, the rule set determining, based on the input credentials, which graphical user interface to generate and which access options to provide;
generating, based on the comparing, the graphical user interface presenting the customer with the access options;
outputting the graphical user interface (GUI), with the access options, to the one of the plurality of customers;
receiving, from the one of the plurality of customers, a selection of one of the access options;
performing processing in response to the selected access option;
receiving, from the one of the plurality of customers, a note describing a transaction performed by the one of the plurality of customers, wherein the GUI (1) displays a transaction history of the group account and (2) interfaces with the one of the plurality of customers to receive the note describing the transaction via the GUI after the transaction has been recorded in the transaction history by the financial entity maintaining the group account; and
outputting to the graphical user interface the note describing the transaction such that each of the plurality of customers associated with the group account can review the note describing the transaction.

2. The method of claim 1, the plurality of customers consisting of one primary customer and a plurality of participant customers, and the primary customer being provided the ability to control the access to the group account.

3. The method of claim 2, wherein access afforded each of the respective participant customers is subject to particular limitations, such particular limitations not applied to the primary customer.

4. The method of claim 2, wherein the access includes both access to information and access to processing tasks.

5. The method of claim 4, wherein:
the access to information includes access to balance information; and
access to processing tasks includes the capability to transfer monies to and from the group account.

6. The method of claim 2, wherein the group account is associated with at least one permanent account of the primary customer, in that the permanent account has no planned close.

7. The method of claim 6, wherein the group account is temporary in that the group account is associated with at least one event to trigger close of the group account.

8. The method of claim 7, wherein the at least one event to trigger close of the group account is a predetermined date in the future.

9. (canceled)

10. The method of claim 7, wherein the at least one event to trigger close of the group account is a predetermined fund amount, such that the group account closes upon the achievement of such predetermined fund amount.

11. The method of claim 7, wherein close of the group account is predetermined to be associated with a funds transfer between the group account and the permanent account.

12. The method of claim 1, wherein the group account, the plurality of customers, and the rule set are maintained in the form of information stored in a record on the computer processing system.

13. The method of claim 12, wherein the computer processing system, based on the information, allocates funds upon close of the group account, to each of the plurality of customers.

14. The method of claim 13, wherein the allocation of funds is based on documented contributions of each respective customer, such documented contributions being stored in records in the computer processing system.

15. The method of claim 12, wherein the computer processing system, based on the information, performs a transfer of access rights from a primary customer to a backup primary customer, upon the primary customer being terminated as a group account customer.

16. The method of claim 1, wherein the computer processing system tracks monetary contributions of each group account customer associated with the group account.

17. The method of claim 16, wherein the tracking of monetary contributions of each group account customer includes the computer processing system requiring documentation in conjunction with any deposit to the group account.

18. The method of claim 1, wherein the computer processing system tracks monetary withdrawals from the group account, and wherein a monetary withdrawal in excess of a predetermined threshold amount requires authorization from two group account customers.

19. The method of claim 1, wherein the credentials are in the form of a user name and password.

20. The method of claim 1, wherein the session includes the computer processing system interfacing with the at least one customer over the Internet.

21. The method of claim 1, wherein the computer processing system is in the form of a bank platform maintained by a bank.

22. A system to provide a group account in the form of a financial fund and maintained by a financial entity, the system in the form of a tangibly embodied computer processor, the group account maintained on the system, the system comprising:
a group account database that maintains the group account, the group account associated with a plurality of customers who each have selective access to the account, such selective access determined by a rule set disposed in the group account database, each of the plurality of customers having an interest in the group account, the group account constituted by a single account in the form of a single financial fund; and
a group account processor in the form of a computer, the group account processor:
receiving credentials from one of the plurality of customers in a session;
comparing the input credentials with the rule set to determine access to the group account to be provided to the customer, wherein the input credentials are mapped to the rule set, the rule set determining, based on the input credentials, which graphical user interface to generate and which access options to provide;
generating, based on the comparing, the graphical user interface (GUI) presenting the customer with the access options;
outputting the graphical user interface, with the access options, to the one of the plurality of customers;
receiving, from the one of the plurality of customers, a selection of one of the access options;
performing processing in response to the selected access option;
receiving, from the one of the plurality of customers, a note describing a transaction performed by the one of the plurality of customers, wherein the GUI (1) displays a transaction history of the group account and (2) interfaces with the one of the plurality of customers to receive the note describing the transaction via the GUI after the transaction has been recorded in the transaction history by the financial entity maintaining the group account; and
outputting to the graphical user interface the note describing the transaction such that each of the plurality of customers associated with the group account can review the note describing the transaction.

23. A method to provide a group account in the form of a financial fund, the group account maintained by a financial entity, the method implemented by a tangibly embodied computer processing system, the group account maintained on the computer processing system, the method including:
maintaining, by the computer processing system, the group account, the group account associated with a plurality of customers who each have selective access to the account, such selective access determined by a rule set disposed in the computer processing system, each of the plurality of customers having an interest in the group account, the group account constituted by a single account in the form of a single financial fund; and
the computer processing system:
receiving credentials from one of the plurality of customers in a session;
comparing the credentials with the rule set to determine access to the group account to be provided to the customer, wherein the credentials are mapped to the rule set, the rule set determining, based on the credentials, which graphical user interface to generate and which access options to provide;
generating, based on the comparing, the graphical user interface (GUI) presenting the customer with the access options;
outputting the graphical user interface, with the access options, to the one of the plurality of customers;
receiving, from the one of the plurality of customers, a selection of one of the access options;
performing processing in response to the selected access option; and
the plurality of customers consisting of one primary customer and a plurality of participant customers, and the primary customer being provided the ability to control the access to the group account;
receiving, from the one of the plurality of customers, a note describing a transaction performed by the one of the plurality of customers, wherein the GUI (1) displays a transaction history of the group account and (2) interfaces with the one of the plurality of customers to receive the note describing the transaction via the GUI after the transaction has been recorded in the transaction history by the financial entity maintaining the group account; and
outputting to the graphical user interface the note describing the transaction such that each of the plurality of customers associated with the group account can review the note describing the transaction;
the access afforded each of the respective participant customers is more limited vis-à-vis the access afforded the primary customer, and wherein the access includes both access to information and access to processing tasks, and wherein:
the access to information includes access to balance information; and
access to processing tasks includes the capability to transfer monies to and from the group account;
wherein the group account is associated with at least one permanent account of the primary customer, in that the permanent account has no planned close;
wherein the group account is temporary in that the group account is associated with at least one event to trigger close of the group account, and wherein the at least one event to trigger close of the group account is a predetermined date in the future;
wherein the group account, the plurality of customers, and the rule set are maintained in the form of information stored in a record on the computer processing system, and wherein the computer processing system, based on the information, allocates funds upon close of the group account, to each of the plurality of customers, and wherein the allocation of funds is based on documented contributions of each respective customer, such documented contributions being stored in records in the computer processing system; and
wherein the computer processing system is in the form of a bank platform maintained by a bank.

24. The method of claim 1, further including providing a debit card to the plurality of customers associated with the group account to allow the plurality of customers to deposit funds to or withdraw funds from the group account.
